(19) United States
(12) Patent Application Publication
(10) Pub. No.: US 2026/0144178 A1
(43) Pub. Date: May 28, 2026

(54) TOOL-CHANGING SYSTEM FOR AN AGRICULTURAL SOIL-WORKING MACHINE, AND METHOD FOR FASTENING A SOIL-WORKING TOOL

(71) Applicant: AMAZONEN-WERKE H. DREYER SE & CO. KG, Hasbergen (DE)

(72) Inventor: Tom MAHLER, Leipzig (DE)

(21) Appl. No.: 19/121,879

(22) PCT Filed: Mar. 4, 2024
(86) PCT No.: PCT/EP2024/055548

§ 371 Date: Apr. 17, 2025

(30) Foreign Application Priority Data
Mar. 16, 2023 (EP) 23401008.0

(51) Int. Cl. A01B 15/06

(52) U.S. Cl. CPC A01B 15/06

(57) ABSTRACT

The invention relates to a tool-changing system (10) for an agricultural soil-working machine, with a soil-working tool (20), a tool carrier (40) for carrying the soil-working tool (20), a tension lever (60) which can be brought into an operational tension state by elastic deformation, in which the tension lever (60) extends at least in sections to the rear of the tool carrier and in which the tension lever (60) tenses the soil-working tool (20) to the tool carrier (40) in an operationally reliable manner, and a locking member (80) which is movable relative to the tool carrier (40) and is designed to lock the tension lever (60) in the operational tension state in a locking position.

The invention relates to a tool-changing system for an agricultural soil-working machine according to the general term of patent claim 1, an agricultural soil-working machine according to the general term of patent claim 12 and a method for fastening a soil-working tool to a tool carrier according to the general term of patent claim 13.

The soil-working tools of agricultural soil-working machines are usually subject to comparatively high wear during use, so that in practice they have to be replaced frequently. In addition, it is often intended to use an agricultural soil-working machine with different soil-working tools which are adapted to a specific working operation, a specific soil type and/or to the requirements of a specific cultivated plant.

In practice, quick-change tool systems are already being used in which the soil-working tool is carried by a tool carrier. The soil-working tool can be tensed to the tool carrier by means of a tension lever in an operationally reliable manner. Such a system is known, for example, from publication WO 2022/184284A1.

The locking mechanism of the tension lever is often a problem with the known systems. For example, ring-shaped locking brackets have been used up to now to lock the tension lever. Such locking brackets tend to deform under permanent dynamic load, so that no permanent reliable locking can be guaranteed. Furthermore, retaining members are known which are molded onto the tool carrier and provide a locking edge for the tension lever. With such locking mechanisms, however, the use of tension tools is regularly required in order to lock the tension bracket to the retaining element formed on the tool carrier.

The task underlying the invention is therefore to make the locking mechanism of the tension lever in a tool-changing system robust against continuous dynamic loading without impairing handling comfort.

The task is solved by a tool-changing system of the type mentioned at the beginning, wherein the securing stop of the locking member intake of the tool-changing system according to the invention is arranged rear to the tension lever in the operational tension state of the tension lever.

As the securing stop is arranged rear to the tension lever in the operational tension state of the tension lever, the locking member, which is located between the tension lever and the securing stop, is subjected to pressure by the restoring force of the tension lever. In this way, tension-loaded locking members, such as locking brackets, can be dispensed with. The compressive load of the locking member allows the use of a compact and at the same time highly resilient locking part and thus leads to a considerably increased continuous load capacity of the locking member, so that a deformation-related impairment of the locking function is excluded. The locking member, which can be moved relative to the tool carrier, also ensures a high degree of handling comfort during the locking process.

The soil-working tool can be set up to be moved through the soil for soil-working. The soil-working tool can be a coulter element or a cutting element, for example a coulter plate or a blade plate or a chopping blade.

The soil-working tool can be changed quickly and without tools using the tool-changing system. The tension lever is preferably brought into the operational tension state by the manual force of an operator. The locking member is preferably designed as a separate part. The locking member can preferably be inserted transversely through the tool carrier. The locking member prevents the tension lever, which is in the operational tension state, from deforming and relaxing again. The restoring force transferred to the locking member also braces the locking member, preventing the locking member from slipping out sideways. The soil-working tool and the tool carrier can preferably be connected to each other backlash-free. The backlash-free connection prevents unintentional movement of the soil-working tool in the event of contact with a body in the soil, for example a root, which improves the work result. In particular, the arrangement according to the invention maintains a backlash-free fit and/or compensates for manufacturing tolerances of the soil-working tool and/or tool carrier, so that operational reliability is also increased.

In a preferred embodiment of the tool-changing system according to the invention, the locking member intake is formed by a locking recess in the tool carrier, in particular in a rear material extension of the tool carrier. The rear material extension is preferably a projection that protrudes or protrudes from the rear. The tool carrier preferably has a stalk-shaped carrier body. The stalk-shaped carrier body and the rear material extension are integral components of a one-piece body, in particular a one-piece metal body.

In a further development of the tool-changing system according to the invention, the locking recess in the tool carrier forming the locking member intake is designed as a through-hole extending in the transverse direction. The through-hole is preferably rectangular, whereby production-related recesses may be present in the corners of the rectangular through-hole. The through-hole preferably has one or more flat inner contour surfaces. The securing stop is formed by one of the inner contour surfaces of the through-hole. The flat inner contour surface of the securing stop allows the locking member to make full-surface contact with the securing stop.

In another preferred embodiment of the tool-changing system according to the invention, the tool carrier comprises a stalk-shaped carrier body with a rear end surface or end edge extending upright at least in sections, wherein the securing stop is formed by a stop surface or stop edge extending parallel and/or offset to the rear relative to the end surface or end edge. The rear end face or end edge preferably points to the rear, i.e. against the direction of processing or travel. The stop surface or stop edge preferably points forwards, i.e. in the direction of processing or travel. The rear end face or end edge and the stop face or stop edge preferably point in opposite directions.

In an advantageous further development of the tool-changing system according to the invention, the locking member has a lateral material recess for receiving a material section carrying the securing stop during the insertion of the locking member into the locking member intake. The locking member is preferably inserted by pushing it sideways into the locking member intake. Lateral insertion is made possible by the material recess of the locking member.

Furthermore, a tool-changing system according to the invention is advantageous, in which the locking member has a grip area on the rear side of the material recess for holding the locking member by an operator. In this way, the locking member can be held securely by the operator during insertion into the locking member holder. The grip area can also be used by an operator to remove the locking member from the locking member intake.

In a further preferred embodiment of the tool-changing system according to the invention, the locking member has a front contact contouring, the shape of which is adapted to the contour of the tension lever. The fact that the shape of the front contact contouring of the locking member is adapted to the contour of the tension lever ensures a secure fit between the locking member and the tension lever. For example, if the contour of the tension lever has a convex, outwardly curved surface in the area of the locking member, the front contact contouring of the locking member has a concave, inwardly curved surface adapted to the convex, outwardly curved surface of the tension lever.

In a further preferred embodiment of the tool-changing system according to the invention, the tension lever is designed as a spring clip, in particular as a bent wire part. In this case, the tension lever can be U-shaped, for example. Two end sections of the wire of the bent wire part can lie directly next to each other. The shape of the tension lever can be mirror-symmetrical in relation to a plane of symmetry, so that it results, for example, from two symmetrically extending wire sections. As a result of this embodiment, the tension lever preferably has an open shape, so that the risk of adhering soil material and plant residues getting caught is particularly reduced.

In another preferred embodiment of the tool-changing system according to the invention, the tension lever is in an upper area circumferential around a free space, through which the locking member intake extends in the operational tension state of the tension lever. In the upper area, the tension lever can, for example, have a loop shape, whereby the free space accommodating the locking member intake is formed by the loop shape.

A tool-changing system according to the invention is also preferred, in which the tension lever has a carrier contact area which, in the operational tension state of the tension lever, is pressed against a lever guide area of the tool carrier, the tension lever in the carrier contact area being secured laterally against lateral movements by securing flanks of the tool carrier. The carrier contact area and the lever guide area together form a pivot bearing for the tension lever, which allows a guided rotary movement of the tension lever over a swivel angle range. The securing flanks serve as lateral stops so that the carrier contact area of the tension lever and the lever guide area of the tool carrier are prevented from going out of contact by a lateral movement of the tension lever and/or tool carrier. The carrier contact area of the tension lever preferably has a convexly curved contact surface. The lever guide area of the tool carrier preferably has a concave curved contact surface.

In a further development of the tool-changing system according to the invention, the tension lever has a locking section which can be inserted into a lever receiving recess of the soil-working tool. By the insertion of the locking section of the tension lever into the lever receiving recess of the soil-working tool, the tension lever is brought into an intermediate state. After insertion of the locking section of the tension lever into the lever receiving recess of the soil-working tool, an upper area of the tension lever must then be pressed in the direction of the tool carrier. The lever receiving recess is preferably arranged in a rear area of the soil-working tool. Once the soil-working tool and tool carrier have been intervented, the lever receiving recess is accessible from the rear of the soil-working tool so that the tension lever can be easily inserted from the top rear. This enables safe and simple assembly of the soil-working tool, as no assembly operations need to be carried out on the underside of the soil-working tool. Preferably, the tool carrier has one or more intervention bodies, whereby each intervention body is designed to intervent in a receiving recess in the soil-working tool. An intervention body is preferably set up to intervent in the lever receiving recess, in which the locking section of the tension lever can also be inserted. The lever receiving recess therefore accommodates both an intervention body and the locking section of the tension lever. The at least one intervention body and the at least one lever receiving recess preferably have corresponding chamfers, in particular in the range between 30 and 60 degrees, particularly preferably 45 degrees, whereby, as a result of the arrangement according to the invention, an at least approximately backlash-free fit is ensured even in the event of wear, because the soil-working tool, the tool carrier and the tension lever adjust each other.

The problem underlying the invention is further solved by an agricultural soil-working machine of the type mentioned at the beginning, wherein the tool-changing system of the soil-working machine according to the invention is designed according to one of the embodiments described above. The agricultural soil cultivating machine is preferably a hoeing machine.

The problem underlying the invention is further solved by a method of the type mentioned at the beginning, wherein the locking member is subjected to pressure in the locking position by the tension lever which is in the operational tension state. The fact that the locking member is subjected to pressure in the locking position results in a considerably increased continuous load capacity and thus an increased life time. Furthermore, the compressive force can be used as a readjustment force in the event of wear on the soil-working tool and/or tool carrier, so that even then an at least almost backlash-free locking is achieved, in particular automatically.

The method according to the invention is further advantageously embodied in that the soil-working tool, the tool carrier, the tension lever and the locking member form a tool-changing system according to one of the embodiments described above. With regard to the advantages and modifications of the method according to the invention, reference is thus made to the advantages and modifications of the tool-changing system according to the invention.

In the following, preferred embodiments of the invention are explained and described in more detail with reference to the accompanying drawings. Showing:

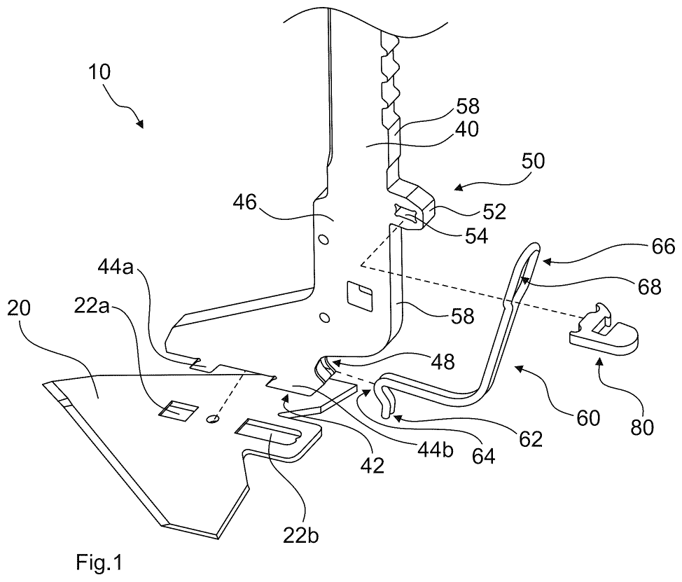

FIG. 1 a schematic exploded-view drawing of a tool-changing system according to the invention;

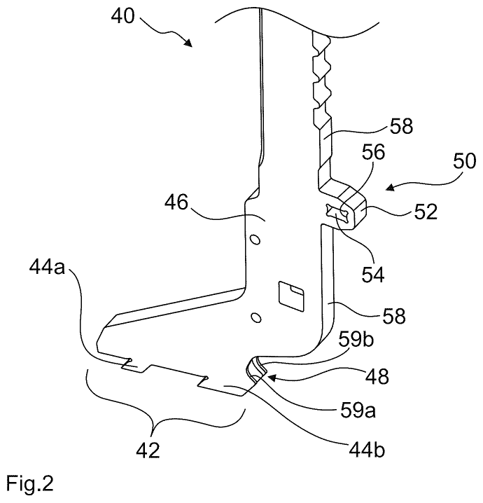

FIG. 2 the tool carrier of the tool-changing system shown in FIG. 1 in a schematic perspective view;

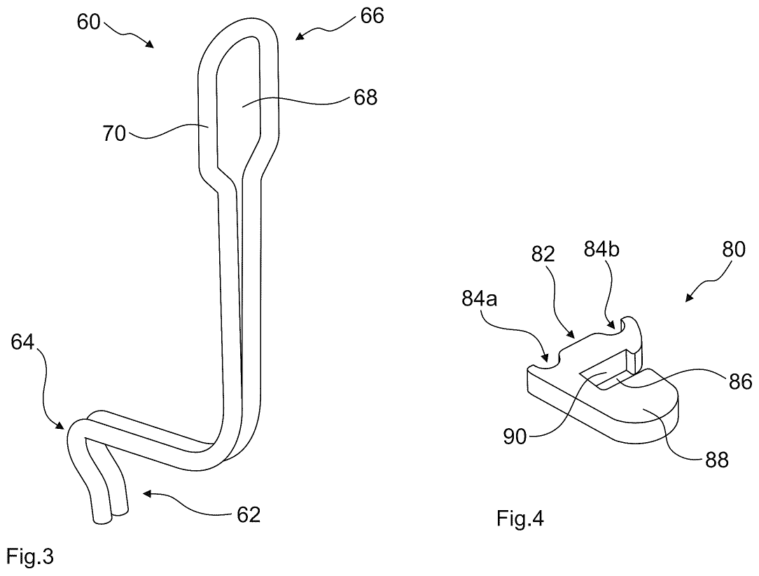

FIG. 3 the tension lever of the tool-changing system shown in FIG. 1 in a schematic perspective view;

FIG. 4 the locking member of the tool-changing system shown in FIG. 1 in a schematic perspective view;

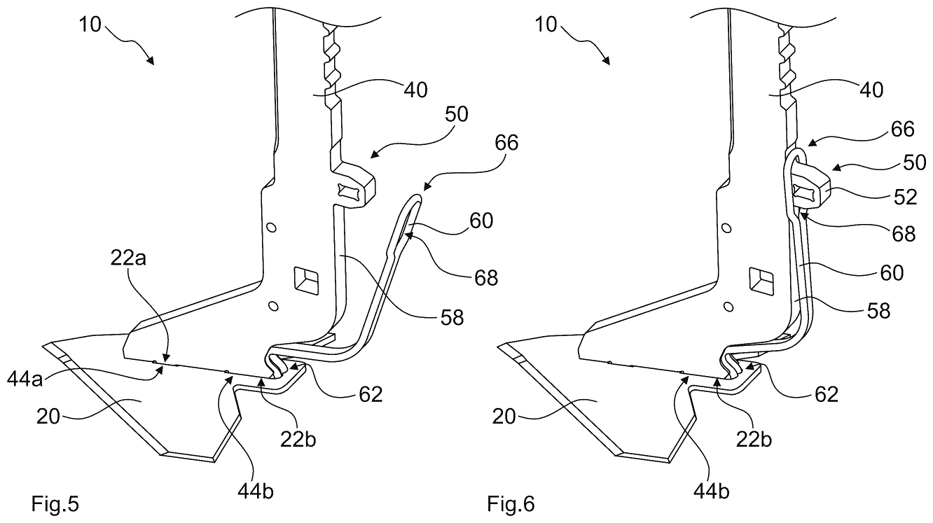

FIG. 5 a tool-changing system according to the invention after insertion of the tension lever into the lever receiving recess of the soil-working tool in a schematic perspective view;

FIG. 6 schematic perspective view of the tool-changing system shown in FIG. 5 with the tension lever pressed against the tool carrier;

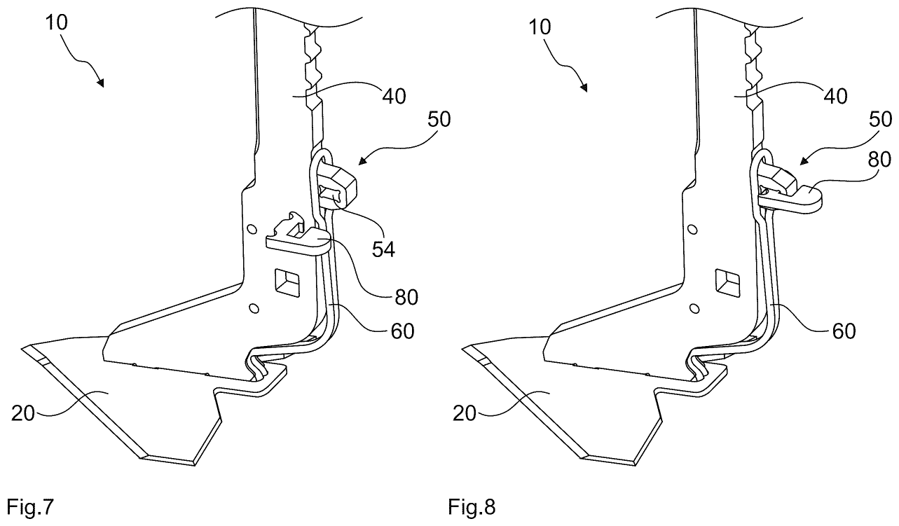

FIG. 7 schematic perspective view of the tool-changing system shown in FIG. 5 with manually fixed tension lever and non-inserted locking element;

FIG. 8 schematic perspective view of the tool-changing system shown in FIG. 5 with manually fixed tension lever and locking member inserted into the locking member intake;

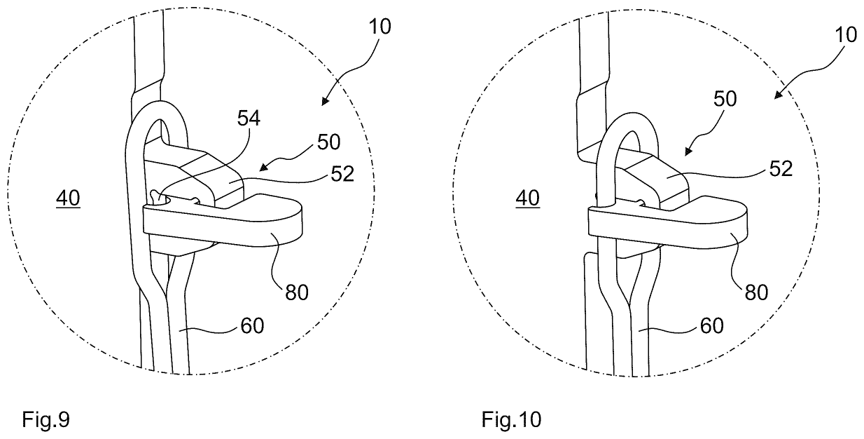

FIG. 9 a detailed illustration in the area of the locking member intake in the state of the tool-changing system shown in FIG. 8;

FIG. 10 the area of the locking member intake shown in FIG. 9 after releasing the manual tension lever fixation;

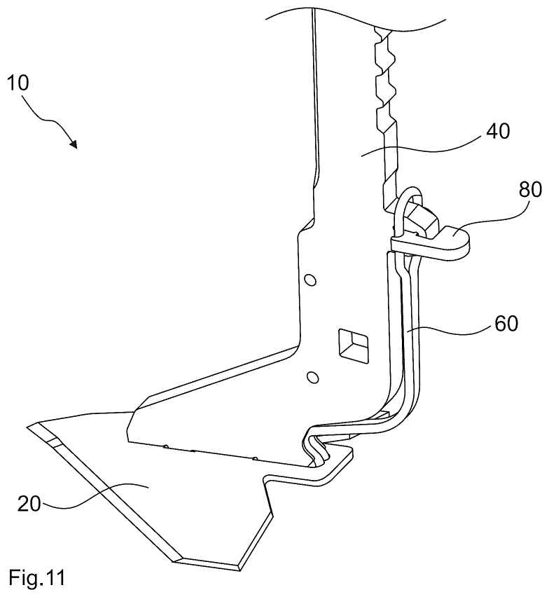

FIG. 11 an overall view of the tool-changing system, which is shown in FIG. 10 in parts;

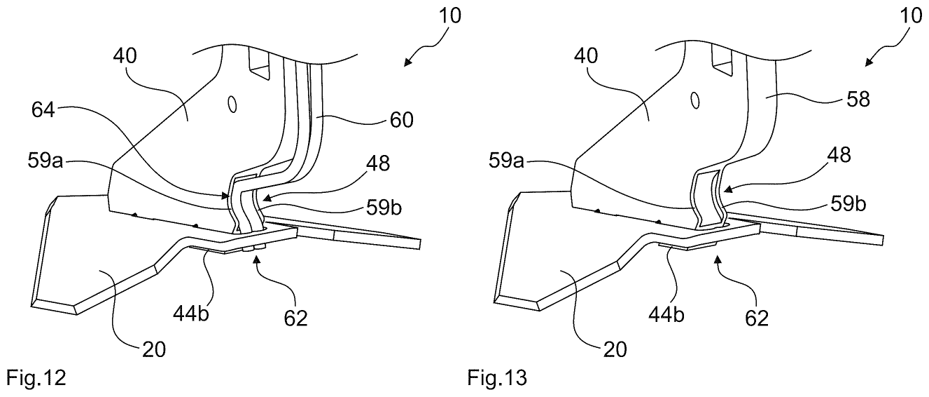

FIG. 12 a tool-changing system according to the invention in a schematic perspective view from behind; and

FIG. 13 the soil-working tool and the tool carrier of the tool-changing system shown in FIG. 12 in a schematic perspective view from behind.

FIG. 1 shows a tool-changing system 10 for an agricultural soil-working machine, namely for a hoeing machine.

The tool-changing system 10 comprises a soil-working tool 20, a tool carrier 40, a tension lever 60 and a locking member 80. The soil-working tool 20 is a blade plate and has an arrow-shaped basic form, also known as a goose foot. The soil-working tool 20 has two receiving recesses 22a, 22b arranged one behind the other in the working direction. The receiving recesses 22a, 22b of the soil-working tool 20 can be brought into intervention with intervention bodies 44a, 44b of the tool carrier 40. The intervention bodies 44a, 44b are located on an intervention section 42 on the underside of the tool carrier 40. The intervention body 44a can be inserted into the receiving recess 22a. The intervention body 44b can be inserted into the receiving recess 22b. The tool carrier 40 has a stalk-shaped carrier body 46, from which a material extension 52 protrudes at the rear. A locking recess 54 is located in the material extension 52.

The tension lever 60 is designed as a bent wire part and has a locking section 62 at its lower end. The locking section 62 can be inserted behind the intervention body 44b in the receiving recess 22b. A carrier contact area 64 of the tension lever 60 can be brought into contact with a lever guide area 48 of the tool carrier 40 by pressing the tension lever 60 in the direction of the tool carrier 40. The carrier contact area 64 and the lever guide area 48 together form a pivot bearing for the tension lever 60, which permits a guided rotary movement of the tension lever 60 over a swivel angle range. The tension lever 60 extends at the rear of the tool carrier 40 and is used to securely tense the soil-working tool 20 to the tool carrier 40.

The tension lever 60 has a free space 68 in an upper area 66, which serves to receive the material extension 52 of the tool carrier 40. When the tension lever 60 rests against the rear end surface 58 of the tool carrier 40, which extends above the material extension 52, the locking member 80 can be inserted into the locking recess 54. The material extension 52 with the locking recess 54 thus serves as a locking member intake 50. The locking member 80 is designed as a separate part and is thus movable relative to the tool carrier 40. After inserting the locking member 80 into the locking recess 54, the locking member 80 serves to lock the tension lever 60 in an operational tension state.

FIG. 2 shows the tool carrier 40 of the tool-changing system 10 shown in FIG. 1. On its underside, the tool carrier 40 has an intervention section 42 with two spaced-apart intervention bodies 44a, 44b. Furthermore, the tool carrier 40 comprises a stalk-shaped carrier body 46 with rear end surfaces 58. A lever guide area 48 for guiding the tension lever 60 is located in a lower section on the rear side. Securing flanks 59a, 59b, which prevent lateral movements of the tension lever 60, run to the side of the lever guide area 48.

Furthermore, the tool carrier 40 comprises a locking member intake 50 for receiving the locking member 80. The locking member intake 50 has a securing stop 56 for receiving a restoring force transmitted to the locking member 80 by the tension lever 60, which is in the operational tension state. The locking member intake 50 is formed by a locking recess 54 in a rear material extension 52 of the tool carrier 40. The rear material extension 52 is a projection which protrudes or protrudes from the rear. The locking recess 54 in the tool carrier 40 forming the locking member intake 50 is designed as a through-hole extending in the transverse direction. The through-hole has a rectangular cross-section, with production-related recesses in the corners. The through-hole has flat inner contour surfaces. The securing stop 56 is formed by the rear inner contour surface of the through-hole and is arranged on the rear side of the tension lever 60 in the operational tension state of the tension lever 60.

FIG. 3 shows the tension lever 60 designed as a bent wire part. The tension lever 60 is a U-shaped spring clip and has an open shape. The shape of the tension lever 60 is mirror-symmetrical in relation to a symmetry plane running through the middle. The tension lever 60 has a free space 68 in an upper area 66, through which the locking member intake 50 extends in the operational tension state of the tension lever 60. In the upper area 66, the tension lever has a loop 70, through which the free space 68 is formed.

FIG. 4 shows the locking member 80. The locking member 80 has a front contact contouring 82, the shape of which is adapted to the contour of the tension lever 60. The front contact contouring 82 of the locking member 80 has two concave, inwardly curved surfaces 84a, 84b adapted to the convex, outwardly curved surfaces of the tension lever wire. Furthermore, the locking member 80 comprises a lateral material recess 86 for receiving a material section of the tool carrier 40 carrying the securing stop 56. The material recess 86 forms a stop surface 90, which can be brought into contact with the securing stop 56. In addition, the locking member 80 has a grip area 88 on the rear side of the material recess 86 for holding the locking member 80 by an operator.

FIGS. 5 to 11 show a tool-changing system 10 during the attachment of a soil-working tool 20 to a tool carrier 40.

As shown in FIG. 5, a soil-working tool 20 is first arranged on a tool receiving area of the tool carrier 40. After arranging the soil-working tool 20 on the tool carrier 40, an intervention body 44a of the tool carrier 40 extends through a receiving recess 22a of the soil-working tool 20 and an intervention body 44b of the tool carrier 40 extends through the receiving recess 22b of the soil-working tool 20.

The tension lever 60 is then inserted into the soil-working tool 20. Here, a locking section 62 of the tension lever 60 is inserted into the receiving recess 22b, in which the intervention body 44b of the tool carrier 40 is already located.

As shown in FIG. 6, the tension lever 60 is then pressed in the direction of the tool carrier 40 so that the material extension 52 of the tool carrier 40 extends through the free space 68 in the upper area 66 of the tension lever 60.

As shown in FIG. 7, the tension lever 60 is now manually fixed in this contact state so that the locking member 80 can be inserted into the locking recess 54.

FIGS. 8 and 9 show a state in which the locking member 80 is inserted into the locking recess 54 in the material extension 52. In this state, the tension lever 60 is still manually fixed to the tool carrier 40 so that there is no contact between the locking member 80 and the tension lever 60.

FIGS. 10 and 11 show the tool-changing system 10 after the manual fixing of the tension lever 60 has been released and the tension lever presses the locking member 80 against a securing stop 56 of the locking member intake 50 due to the restoring force. The locking member 80 is now in the locking position, whereby the tension lever 60 is locked in an operating tension position by the locking member 80 located in the locking position. The locking member 80 is subjected to pressure by the restoring force of the tension lever 60. The restoring force of the tension lever 60 transmitted to the locking member 80 also tenses the locking member 80 itself in such a way that the locking member 80 is prevented from slipping out to the side.

To release the soil-working tool 20 from the tool carrier 40, the tension lever 60 is to be pressed manually again in the direction of the tool carrier 40, so that the locking member 80 can be removed from the locking member intake 50. After removing the locking member 80 from the locking member intake 50, the return movement of the tension lever 60 is no longer blocked, so that the deformation of the tension lever 60 leading to the tension can be released. The tension-free tension lever 60 can then be removed again from the receiving recess 22b of the soil-working tool 20, whereby the soil-working tool 20 can be released from the tool carrier 40.

FIGS. 12 and 13 show that the tension lever 60 has a carrier contact area 64, which is pressed against a lever guide area 48 of the tool carrier 40 in the operational tension state of the tension lever 60, whereby the tension lever 60 is secured laterally in the carrier contact area 64 by securing flanks 59a, 59b of the tool carrier 40 against lateral movements. The carrier contact area 64 and the lever guide area 48 together form a pivot bearing for the tension lever 60, which permits a guided rotary movement of the tension lever 60 over a swivel angle range. The carrier contact area of the tension lever 60 has a convexly curved contact surface. The lever guide area 48 of the tool carrier 40 has a concave curved contact surface.

### REFERENCE SIGNS

10 Tool-changing system
20 Soil-working tool
22a, 22b Receiving recesses
40 Tool carrier
42 Intervention section
44a, 44b Intervention body
46 Stalk shaped carrier body
48 Lever guide area
50 Locking member intake
52 Material extension
54 Locking recess
56 Securing stop
58 End surfaces
59a, 59b Securing flanks
60 Tension lever
62 Locking section
64 Carrier contact area
66 Upper area
68 Free space
70 Loop
80 Locking member
82 Contact contouring
84a, 84b Inwardly curved surface
86 Material recess
88 Grip area
90 Stop surface

1. Tool-changing system (10) for an agricultural soil-working machine, with
a soil-working tool (20);
a tool carrier (40) for carrying the soil-working tool (20);
a tension lever (60) which can be brought into an operational tension state by elastic deformation, in which the tension lever (60) extends at least in sections to the rear of the tool carrier and in which the tension lever (60) tenses the soil-working tool (20) to the tool carrier (40) in an operationally reliable manner; and
a locking member (80), which is movable relative to the tool carrier (40) and is designed to lock the tension lever (60) in the operational tension state in a locking position;
wherein the tool carrier (40) comprises a locking member intake (50) for receiving the locking member (80) and the locking member intake (50) has a securing stop (56) for receiving a restoring force transmitted to the locking member (80) by the tension lever (60) which is in the operational tension state, characterized in that the securing stop (56) is arranged rear to the tension lever (60) in the operational tension state of the tension lever (60).

2. Tool-changing system (10) according to claim 1, characterized in that the locking member intake (50) is formed by a locking recess (54) in the tool carrier (40), in particular in a rear material extension (52) of the tool carrier.

3. Tool-changing system (10) according to claim 2, characterized in that the locking recess (54) in the tool carrier (40) forming the locking member intake (50) is designed as a through-hole extending in the transverse direction.

4. Tool-changing system (10) according to one of the preceding claims, characterized in that the tool carrier (40) comprises a stalk-shaped carrier body (46) with a rear end surface (58) or end edge extending upright at least in sections, wherein the securing stop (56) is formed by a stop surface or stop edge extending parallel and/or offset to the rear relative to the end surface (58) or end edge.

5. Tool-changing system (10) according to one of the preceding claims, characterized in that the locking member (80) has a lateral material recess (86) for receiving a material section carrying the securing stop (56) during the insertion of the locking member (80) into the locking member intake (50).

6. Tool-changing system (10) according to claim 5, characterized in that the locking member (80) has a grip area (88) on the rear side of the material recess (86) for holding the locking member (80) by an operator.

7. Tool-changing system (10) according to one of the preceding claims, characterized in that the locking member (80) has a front contact contouring (82), the shape of which is adapted to the contour of the tension lever (60).

8. Tool-changing system (10) according to one of the preceding claims, characterized in that the tension lever (60) is designed as a spring clip, in particular as a bent wire part.

9. Tool-changing system (10) according to one of the preceding claims, characterized in that the tension lever (60) is in an upper area (66) circumferential around a free space (68), through which the locking member intake (50) extends in the operational tension state of the tension lever (60).

10. Tool-changing system (10) according to one of the preceding claims, characterized in that the tension lever (60) has a carrier contact area (64) which, in the operational tension state of the tension lever (60), is pressed against a lever guide area (48) of the tool carrier (40), the tension lever (60) in the carrier contact area (64) being secured laterally against lateral movements by securing flanks (59a, 59b) of the tool carrier (40).

11. Tool-changing system (10) according to one of the preceding claims, characterized in that the tension lever (60) has a locking section (62) which can be inserted into a lever receiving recess (22b) of the soil-working tool (20).

12. Agricultural soil-working machine, with
a tool-changing system (10),
characterized in that the tool-changing system (10) is designed according to one of the preceding claims.

13. Method for fastening a soil-working tool (20) to a tool carrier (40) by means of a tension lever (60) and a locking member (80), comprising the steps of:
arranging the soil-working tool (20) on a tool intake area of the tool carrier (40);
inserting the tension lever (60) into a receiving recess (22b) of the soil-working tool (20), so that the tension lever (60) extends at least in sections to the rear of the tool carrier (40);
bringing the tension lever (60) into an operational tension state by pressing the tension lever (60) in the direction of the tool carrier (40), the tension lever (60) undergoing elastic deformation when it is brought into the operational tension state and the tension lever (60) tenses the soil-working tool (20) to the tool carrier (40) in the operational tension state in an operationally reliable manner; and
bringing the locking member (80) into a locking position by moving the locking member (80) relative to the tool carrier (40), wherein the tension lever (60) is locked in the operational tension state by the locking member (80) being in the locking position;
wherein the locking member (80) is inserted into a locking member intake (50) when it is moved into the locking position, and the locking member intake (50) has a securing stop (56) for receiving a restoring force transmitted to the locking member (80) by the tension lever (60) which is in the operational tension state,
characterized in that the locking member (80) is subjected to pressure in the locking position by the tension lever (60) which is in the operational tension state.

14. Method according to claim 13,
characterized in that the soil-working tool (20), the tool carrier (40), the tension lever (60) and the locking member (80) form a tool-changing system (10) according to one of claims 1 to 11.
